(19) United States
(12) Patent Application Publication
(10) Pub. No.: US 2014/0279291 A1
(43) Pub. Date: Sep. 18, 2014

(54) SYSTEMS AND METHODS FOR COMMUNICATING TO A COMPUTING DEVICE INFORMATION ASSOCIATED WITH THE REPLENISHMENT STATUS OF A RETAIL ITEM

(71) Applicant: TOSHIBA GLOBAL COMMERCE SOLUTIONS HOLDINGS CORPORATION, Research Triangle Park, NC (US)

(72) Inventors: Susan W. Brosnan, Durham, NC (US); Devin S. Brown, Durham, NC (US); James P. Bowles, Durham, NC (US)

(73) Assignee: Toshiba Global Commerce Solutions Holdings Corporation, Research Triangle Park, NC (US)

(21) Appl. No.: 13/803,766

(22) Filed: Mar. 14, 2013

(51) Int. Cl. G06Q 10/08

(52) U.S. Cl. CPC G06Q 10/087
USPC 705/28; 235/385

(57) ABSTRACT

Systems and methods for communicating to a computing device information associated with the replenishment status of a retail item are disclosed herein. According to an aspect, a method may include, at a first computing device, receiving, from a second computing device, a request for notification of replenishment of an item at a retail environment. The method may include determining replenishment status of the item at the retail environment. The method may also include communicating, to the second computing device, information associated with the replenishment status of the item.

### BACKGROUND

1. Field of the Invention

The present invention relates to providing inventory replenishment status in a retail setting, and more specifically, to communicating to a computing device information associated with the replenishment status of a retail item.

2. Description of Related Art

In retail environments, such as grocery stores and other “brick and mortar” stores, successful management of product inventory is important for customer satisfaction. These stores will typically try to manage inventory so that a particular retail item is never out of stock, however, in certain instances a customer may request an item that is either out of stock or not typically carried in inventory by a given store. Stores have traditionally offered a customer the option of purchasing an out of stock item for pickup at a later date, a process generally referred to as issuing a rain check. If the store does not issue rain checks or if the customer does not want to be involved in the rain check process, the customer may have to return frequently to the store in order to determine if the particular out of stock item has been replenished in inventory. The customer may decide to visit another store to determine if that store carried the particular out of stock item. Store personnel could call or otherwise communicate with the shopper when an item has been replenished, however, doing so utilizes valuable store resources and is inefficient. For at least these reasons, it is desired to develop a new system and method of providing replenishment status of an out of stock item to a customer.

### BRIEF SUMMARY

Systems and methods for communicating to a computing device information associated with the replenishment status of a retail item are disclosed herein. According to an aspect, a method may include, at a first computing device, receiving, from a second computing device, a request for notification of replenishment of an item at a retail environment. The method may include determining replenishment status of the item at the retail environment. The method may also include communicating, to the second computing device, information associated with the replenishment status of the item.

According to another aspect, a method may include, at a first computing device, receiving an identifier of an item. The method may include receiving user input for requesting notification of replenishment of the item at a retail environment. The method may include communicating or transmitting, to a second computing device, a request for notification of replenishment of the item at the retail environment.

According to another aspect, a system may include an inventory management module configured to receive, from a computing device, a request for notification of replenishment of an item at a retail environment. The inventory management module may be further configured to determine replenishment status of the item at the retail environment. The inventory management module may be configured to communicate, to the computing device, information associated with the replenishment status of the item.

### BRIEF DESCRIPTION OF THE SEVERAL VIEWS OF THE DRAWINGS

FIG. 1 is a block diagram of an inventory replenishment notification system according to embodiments of the present invention;

FIG. 2 is a flowchart of an example method for communicating to a computing device information associated with the replenishment status of a retail item in accordance with embodiments of the present invention;

FIG. 3 is a flowchart of an example method for communicating to a computing device a request for notification of the replenishment status of a retail item in accordance with embodiments of the present invention; and

FIG. 4 is a flowchart of an example method for communicating to a computing device information associated with the replenishment status of a retail item in accordance with embodiments of the present invention.

### DETAILED DESCRIPTION

Systems and methods for communicating to a computing device information associated with the replenishment status of a retail item are disclosed herein. According to an aspect, a method may include, at a first computing device, receiving, from a second computing device, a request for notification of replenishment of an item at a retail environment. The method may include determining replenishment status of the item at the retail environment. The method may also include communicating, to the second computing device, information associated with the replenishment status of the item.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, a server or other computer located within a retail environment and communicatively connected to other computing devices (e.g., point-of-sale (POS) equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The presently disclosed invention is now described in more detail. For example, FIG. 1 illustrates a block diagram of an inventory replenishment notification system 100 according to embodiments of the present invention. The system 100 may be implemented in whole or in part in any suitable environment for conducting purchase transactions. For example, the system 100 may be implemented in a retail store having a variety of products or items for purchase. A respective product or item for purchase may have an item tag 102 that contains identifying information about a particular product item. The item tag 102 may be physically attached to the item or packaging or may be displayed in closely-spaced relation to the particular product item. The item tag 102 may contain, for example, identifying information or indicia such as, but not limited to, a bar code such as a SKU number or UPC number, a QR code, a store item number, radio frequency identification (RFID) tag, and the like.

The system 100 may further include a server 104. The server 104 may include an inventory management module 106, communications module 108, and memory 110. The server 104 may be configured to communicate via networks 112 and 114. Network 112 may be a wireless local area network (WLAN) managed by the retailer. Network 114 may be the Internet, a mobile network, and/or the like. The inventory management module 106 and memory 110 may include information related to store inventory, identifying information or indicia for a particular product, store location information, customer identification information such as “loyalty program” information, and the like. The inventory management module 106 may be implemented by hardware, software, firmware, or combinations thereof. For example, the module 106 may be implemented by one or more processors and memory.

The server 104 may be communicatively connected to a mobile computing device 116 via network 112 and network 114. The mobile computing device 116 may include a communications module 118, an item notification module 120, a user interface 122, an item identification reader 124, and a memory 126. The module 120 may be implemented by hardware, software, firmware, or combinations thereof. For example, the module 120 may be implemented by one or more processors and memory. In an example, the module 120 may be an application (often referred to as an “app”) residing on the computing device 116. The communications module 118 may include, for example, cellular, wireless, or wired communications capabilities and may be configured to communicate with the server 104 via network 112 and network 114. The communications module 118 may be configured for sending and receiving communications to and from other computing devices. Communication may be implemented by, for example, near field communication techniques.

The item identification reader 124 may be configured to identify an item tag 102 associated with a given product. For example, the item identification reader 124 may be an image capturing device such as a digital camera that is configured to capture an image of the item tag 102 for use in identifying the item or product corresponding to the item tag 102. Alternatively, the item identification reader 124 may be a bar code reader that is configured to scan a UPC/EAN bar code, QR code, and the like. Additionally, the item identification reader 124 may be a reader configured for reading one of an item number, SKU number, serial number, RFID tags, and the like from the item tag 102. As an example, an RFID tag may be read by a suitable NFC technique. Additionally, a user may interact with the user interface 122 to manually enter information from the item tag 102, such as an item number, SKU number, serial number, item name, and the like. The user may also be able to enter a number of the quantity of a particular out-of-stock item that he or she would like to purchase. The user may enter this information through the user interface 122, which may be, for example, a keyboard, touch screen display, or the like for entering information.

Subsequent to entering the item identifier, the mobile computing device 116 may communicate the item identifier to the server 104 via network 112 or network 114. The mobile computing device 116 may also communicate the quantity of the item that the user would like to purchase and an identifier of the user or device 116. The user or device identifier may be used for performing a lookup for stored information about the user or device for, for example, communicating with the user or device. In response to receipt of the information, the item notification module 120 may provide notification of replenishment of an item to a user by a variety of methods. For example, the item notification module 120 may provide a text message, a multimedia service message, a phone call (e.g., an automated phone call), email, or other notification to the operator when an out-of-stock item has been replenished. The module 120 may check the status of the item within a database containing data about the inventory of the store.

The mobile computing device 116 is configured to communicate with server 104 via network 112. In accordance with an aspect of the invention, network 112 may be, for example, a WLAN provided by the retail establishment. The mobile computing device 116 is configured to communicate an item identification message 128 to the server 104 via network 112 and communications module 108. The item identification message 128 may include, for example, the item tag 102 information of a given out-of-stock product and identifying information about the mobile computing device 116. For example, the identifying information about the mobile computing device 116 may be a user's cellular number, home telephone number, email address, fax address, mailing address, or a user name assigned by the retail establishment. Upon receipt of the item identification message 128, the inventory management module 106 may be further configured to verify that a given item is out-of-stock or if additional quantities of an item are available at the retail establishment but are not displayed to areas accessed by a customer.

The inventory management module 106 may continuously or periodically check the status of items identified as out-of-stock by a customer to determine the replenishment status of an item. As used herein, replenishment status may mean, for example, when a given item has replenished inventory within any portion of a retail establishment, when a given item is restocked in areas into which customers have access to, such as, for example, product shelving, or when an inventory level meets a predetermined amount, such as, for example, when the quantity of a given item matches or exceeds the number of users who have identified a particular item as out-of-stock. In the event that the inventory management module 106 determines that an out-of-stock item has been replenished, the server 104 is configured to communicate a replenishment status message 130 via network 114 to the mobile computing device 116 where the item notification module 120 displays or otherwise communicates the information to the user. The replenishment status message 130 may identify, for example, which item has been replenished, the number of items in inventory, the retail establishment location, and any other relevant information. Network 114 may be a cellular network when, for example, the replenishment status message 130 is a text message, phone call, or email. Additionally, network 114 may be a wireless internet-based network WI-FI® if, for example, a given user is still within the retail establishment and communicating with the retail establishment's WI-FI® network.

The inventory management module 106 may be configured to communicate with a computing device of a user to notify the user of a replenishment of an out-of-stock item. As an example, FIG. 2 illustrates a flowchart of an example method for providing notification of replenishment of an out-of-stock item to a customer. The method of FIG. 2 is described as being implemented by the server 104 shown in FIG. 1, although the method may be implemented by any suitable computing device. The method may be implemented by hardware, software, and/or firmware of the server 104 and/or another computing device.

Referring to FIG. 2, the method includes receiving 204 a request for notification of replenishment of an item at a retail environment. This request may be from a computing device such as the mobile computing device 116. In accordance with an embodiment of the invention, the computing device may be a kiosk or other terminal provided at a retail establishment. The request for notification of replenishment may include the item identification message 128 and may be communicated by the communications module 118 via network 112. The request may be communicated via a wireless network at a retail establishment. The request for notification of replenishment may include additional information, such as, for example, identification information associated with the computing device 116.

The method of FIG. 2 includes determining 202 replenishment status of the item at the retail environment. Determining 202 replenishment status may be performed by the inventory management module 106. The management module 106 may determine replenishment status performed continuously, at intervals, or at predetermined times as determined by the retail establishment. For example, the management module 106 may determine that a given item has been replenished when additional quantities of the item arrive at the retail establishment. Alternatively, the management module 106 may determine that a given item has been replenished when the item is restocked in areas into which customers have access to, such as, for example, product shelving. An employee of the retail establishment may communicate with the management module 106 that a given item has been restocked onto, for example, product shelving.

The method of FIG. 2 includes communicating 204 information associated with the replenishment status of the item. Communicating 204 information associated with the replenishment status of the item may be performed by the communications module 108 of the server 104 and is communicated to, for example, mobile computing device 116 by communicating a replenishment status message 130 via network 114. The user may have the option of “reserving” a replenished item through the item notification module 120 on the mobile computing device 116.

In an example, upon determining the replenishment status of an item by the inventory management module 106, the communications module 108 may communicate information such as, that a given item has been replenished, the quantity of that replenish item in inventory, the retail establishment location where the quantity of replenished items is located, and any other relevant information. Communicating 204 information associated with the replenishment status of the item may be via text message, phone call, email, and the like. The inventory management module 106 may be configured such that communicating 204 information associated with the replenishment status of the item may be performed at a predetermined time or interval. In an example, it may be desirable for the retailer to communicate replenishment status of an item at a desired time of day in order to moderate retail environment traffic. Additionally, it may be desirable for the inventory management module 106 to determine that multiple items identified by a user as out-of-stock have been replenished such that the communications module 108 communicates a replenishment status message 130 to a given user only once.

In accordance with embodiments of the present invention, FIG. 3 illustrates a flowchart of an example method for communicating a request for notification of replenishment of an item in a retail environment. The method of FIG. 3 is described as being implemented by the mobile computing device 116 shown in FIG. 1, although the method may be implemented by any suitable computing device. The method may be implemented by hardware, software, and/or firmware of the mobile computing device 116 and/or another computing device.

Referring to FIG. 3, the method includes receiving 300 an identifier of an item. In an example, the identifier of an item may be information that the mobile computing device 116 is able to determine using the item identification reader 124 and interacting with the item tag 102. The identifier of an item may include, for example, identifying information or indicia such as, but not limited to, a bar code such as a SKU number or UPC number, a QR code, a store item number, and the like. A digital camera, bar code reader, and the like may be provided by the item reader 124 and configured to interact with the item tag 102 to receiving identification of an item.

The method of FIG. 3 includes receiving 302 user input for requesting notification of replenishment of the item at a retail environment 302. In an example, the request may be the item identification message 128 communicated by communications module 118 via network 112 to communications module 108 of server 104. In this example, the network 112 may be a wireless network in the retail establishment. The item identification message 128 may include, for example, the item tag 102 information of a given out-of stock product and identifying information about the mobile computing device 116. For example, item identification message 128 may include bar code identification information associated with a given item indicated as out-of-stock. Additionally, the item identification message 128 may include information associated with identification of the mobile computing device 116, such as, for example, a user's cellular number, home telephone number, email address, fax address, mailing address, or a user name assigned by the retail establishment.

The method of FIG. 3 includes communicating 304 a request for notification of replenishment of the item at the retail environment. For example, the communications module 118 of the mobile computing device 116 may be configured to communicate to the communications module 108 of the server 104 a request for notification of replenishment of the item. This request may be performed over network 112 in the retail environment. The request may include the item identification message 128 and other identification information, such as, for example, input that is indicative of the identifier, that is communicated to server 104.

In accordance with embodiments of the present invention, FIG. 4 illustrates a flowchart of an example method for communicating information associated with the replenishment status of an item to a customer. The method of FIG. 4 is described as being implemented by the server 104 shown in FIG. 1, although the method may be implemented by any suitable computing device. The method may be implemented by hardware, software, and/or firmware of the server 104 and/or another computing device.

Referring to FIG. 4, the method includes receiving 400 a request for notification of replenishment of an item at a retail environment from a mobile computing device. This request may be from a computing device such as the mobile computing device 116. In an embodiment of the invention, the mobile computing device 116 may be a smart-phone. The request for notification of replenishment may include the item identification message 128 and may be communicated by the communications module 118 via network 112. The request may be communicated via a wireless network at a retail establishment. The request for notification of replenishment may include additional information, such as, for example, identification information associated with the computing device 116.

The method of FIG. 4 includes receiving 402 identification information associated with the mobile computing device. Receiving 402 identification information associated with the mobile computing device may be performed when the communications module 108 receives an item identification message 128 from the mobile computing device 116. The identification information may be a user's cellular number assigned to, for example, a smart phone, home telephone number, email address, fax address, mailing address, or a user name assigned by the retail establishment.

The method of FIG. 4 includes storing 404 customer identification information and communication address associated with the customer identifier. Storing 404 customer identification may be performed by the inventory management module 106 storing such information in memory 110 on the server 104. This information may include, for example, information related to a “loyalty program” or the like provided by the retail establishment. In an embodiment of the invention, the inventory management module 106 may be further configured to associate the customer identifier information with corresponding information relating to a customer in a retail establishment's loyalty program.

The method of FIG. 4 includes determining 406 replenishment status of the item at the retail environment. Determining 406 replenishment status may be performed by the inventory management module 106. The management module 106 may determine replenishment status performed continuously, at intervals, or at predetermined times as determined by the retail establishment. For example, the management module 106 may determine that a given item has been replenished when additional quantities of the item arrive at the retail establishment. Alternatively, the management module 106 may determine that a given item has been replenished when the item is restocked in areas into which customers have access to, such as, for example, product shelving. An employee of the retail establishment may communicate with the management module 106 that a given item has been restocked onto, for example, product shelving.

The method of FIG. 4 includes communicating 408 information associated with the replenishment status of the item to the mobile computing device. Communicating 408 information associated with the replenishment status of the item may be performed by the communications module 108 of the server 104 and is communicated to, for example, mobile computing device 116 by communicating a replenishment status message 130 via network 114.

In an example, upon determining the replenishment status of an item by the inventory management module 106, the communications module 108 may communicate information such as, that a given item has been replenished, the quantity of that replenish item in inventory, the retail establishment location where the quantity of replenished items is located, and any other relevant information. Communicating 408 information associated with the replenishment status of the item may be via text message, phone call, email, and the like. The inventory management module 106 may be configured such that communicating 408 information associated with the replenishment status of the item may be performed at a predetermined time or interval. In an example, it may be desirable for the retailer to communicate replenishment status of an item at a desired time of day in order to moderate retail environment traffic. Additionally, it may be desirable for the inventory management module 106 to determine that multiple items identified by a user as out-of-stock have been replenished such that the communications module 108 communicates a replenishment status message 130 to a given user only once.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a first computing device comprising at least a processor and memory:
receiving, from a second computing device, a request for notification of replenishment of an item at a retail environment;
determining replenishment status of the item at the retail environment; and
communicating, to the second computing device, information associated with the replenishment status of the item.

2. The method of claim 1, wherein receiving a request comprises receiving the request via a wireless local area network (WLAN).

3. The method of claim 1, wherein receiving a request comprises receiving the request via a mobile communications network.

4. The method of claim 1, wherein the request includes one of bar code identification information, QR code, a store item number, and a radio frequency identification (RFID) tag associated with the item.

5. The method of claim 1, further comprising receiving, at the first computing device, identification information associated with the second computing device.

6. The method of claim 5, wherein the identification information is one of an email address and text message address.

7. The method of claim 6, further comprising storing, at the first computing device:
a customer identifier associated with the second computing device; and
communication address information associated with the customer identifier; and
wherein communicating information comprises communicating the information based on the address information associated with the customer identifier

8. The method of claim 1, further comprising:
determining an identifier of the item; and
using the identifier to access inventory information about the item in a database.

9. The method of claim 1, wherein communicating information comprises communicating the information via a mobile communications network.

10. The method of claim 1, wherein communicating information comprises communicating a text message, to the second computing device, that includes the information.

11. The method of claim 1, wherein communicating information comprises communicating an email, to the second computing device, that includes the information.

12. The method of claim 1, wherein determining replenishment status of the item comprises determining whether the item has been replenished within inventory of the retail environment, and
wherein communicating information comprises communicating, to the second computing device, information indicating that the item has been replenished in response to determining that the item has been replenished within the inventory of the retail environment.

13. The method of claim 1, wherein communicating information comprises communicating, to the second computing device, inventory replenishment levels in response to determining that the item has been replenished within the inventory of the retail environment.

14. A method comprising:
at a first computing device comprising at least a processor and memory:
receiving an identifier of an item;
receiving user input for requesting notification of replenishment of the item at a retail environment;
communicating, to a second computing device, a request for notification of replenishment of the item at the retail environment.

15. The method of claim 14, wherein receiving an identifier comprises receiving bar code identification information associated with the item.

16. The method of claim 14, wherein receiving user input comprises receiving user input that is indicative of the identifier.

17. The method of claim 14, wherein communicating a request comprises communicating the request via a mobile communications network.

18. The method of claim 14, wherein communicating a request comprises communicating the request via a wireless local area network (WLAN).

19. The method of claim 14, further comprising using interface hardware to read a tag including the identifier.

20. The method of claim 19, wherein using interface hardware comprises using a camera to capture an image of a bar code including the identifier.

21. The method of claim 19, wherein using interface hardware comprises using a scanner to read a bar code including the identifier.

22. The method of claim 14, further comprising sending, from the second computing device, information associated with a replenishment status of the item.

23. A system comprising:
at least a processor and memory; and
an inventory management module configured to:
receive, from a computing device, a request for notification of replenishment of an item at a retail environment;
determine replenishment status of the item at the retail environment; and
communicate, to the computing device, information associated with the replenishment status of the item.

24. The system of claim 23, wherein the inventory management module is further configured to receive, from the computing device, identification information associated with the computing device.

25. The system of claim 24, wherein the inventory management module is further configured to receive a communication address associated with the computing device.
